(19) United States
(12) Patent Application Publication
(10) Pub. No.: US 2026/0061434 A1
(43) Pub. Date: Mar. 5, 2026

(54) WEAR-RESISTANT CYCLONE

(71) Applicant: ENERCORP ENGINEERED SOLUTIONS INC., Calgary (CA)

(72) Inventor: Rory Nagge, Calgary (CA)

(21) Appl. No.: 19/296,431

(22) Filed: Aug. 11, 2025

Related U.S. Application Data
(60) Provisional application No. 63/688,344, filed on Aug. 29, 2024.

(51) Int. Cl. B04C 5/085

(52) U.S. Cl. CPC B04C 5/085

(57) ABSTRACT

A separation system includes a body having an inlet configured to receive a mixed fluid. The mixed fluid includes a liquid and solids. The body also has a first outlet and a second outlet that is positioned below the first outlet. The separation system also includes a wear-resistant insert positioned within the body. The wear-resistant insert includes a plurality of tiles. The wear-resistant insert at least partially defines a vortical flow chamber that is configured to separate the solids from the liquid. The liquid exits the body via the first outlet. The solids exit the body via the second outlet.

### BACKGROUND

Hydraulic fracturing is a well-treatment process in which preferential flow paths for hydrocarbons are established in a subterranean rock formation by pumping a fluid at high pressures into a well to initiate fractures in the rock formation. The fluid is predominately water, but may also include solids, such as sand or ceramic proppants, which at least partially fill the fractures and maintain the preferential flow paths.

When oil or other fluids are produced/recovered from the well, it may be desirable to remove sand or other solids from the produced fluid. Typically, a separator system is used, which may include one or more separation devices (“separators”), filters, screens, tanks, etc. The separator system is generally connected to a wellhead via pipes or tubing. The fluid thus flows from well, into the wellhead, and then to the separator system, where the solids are separated out. The solids may be stored in a tank and periodically removed, while the fluids may be further separated (e.g., to separate hydrocarbons from water). Recovered hydrocarbons may be stored or otherwise transported for sale, and recovered water may be stored or otherwise recirculated for use in the well.

The separators may be vortical flow or “cyclonic” separators that provide a vortical flow chamber therein. The particulate-laden fluids recovered from the well are introduced into this vortical flow chamber, generally through a tangential inlet. The vortical flow chamber typically has an opening in the top through which an outlet tube is received that extends into the vortical flow chamber. The lighter fluids exit up through this outlet tube. The separators also have an opening in the bottom, through which the heavier solids are received. The fluids received into the inlet may be at relatively high pressures and speed, and, since they include particulate matter such as sand, may be abrasive to the structure defining the vortical flow chamber and can lead to frequent maintenance requirements for the wellhead systems and relatively short lifecycles for the separators.

However, the speed, the pressure, and the particulate matter in the fluid may cause wear (i.e., damage) to the inner surfaces of the separator. Therefore, what is needed is an improved system and method for separating a particulate-laden fluid into a solids portion and a liquid portion.

### SUMMARY

A separation system is disclosed. The separation system includes a body having an inlet configured to receive a mixed fluid. The mixed fluid includes a liquid and solids. The body also has a first outlet and a second outlet that is positioned below the first outlet. The separation system also includes a wear-resistant insert positioned within the body. The wear-resistant insert includes a plurality of tiles. The wear-resistant insert at least partially defines a vortical flow chamber that is configured to separate the solids from the liquid. The liquid exits the body via the first outlet. The solids exit the body via the second outlet.

### BRIEF DESCRIPTION OF THE DRAWINGS

The present disclosure may best be understood by referring to the following description and the accompanying drawings that are used to illustrate embodiments of the invention. In the drawings:

FIG. 1 illustrates a perspective view of a separation system, according to an embodiment.

FIG. 2 illustrates a cross-sectional view of the separation system shown in FIG. 1, according to an embodiment.

FIG. 3 illustrates a perspective view of a wear-resistant insert including a plurality of square tiles that may be positioned within the separation system, according to an embodiment.

FIG. 4 illustrates a perspective view of interlocking tiles, according to an embodiment.

FIG. 5 illustrates a perspective view of triangular tiles, according to an embodiment.

FIG. 6 illustrates a usable area of a tile, according to an embodiment.

FIGS. 7 and 8 illustrate a faceted internal surface in the separation system that includes small tiles (FIG. 7) and large tiles (FIG. 8), according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

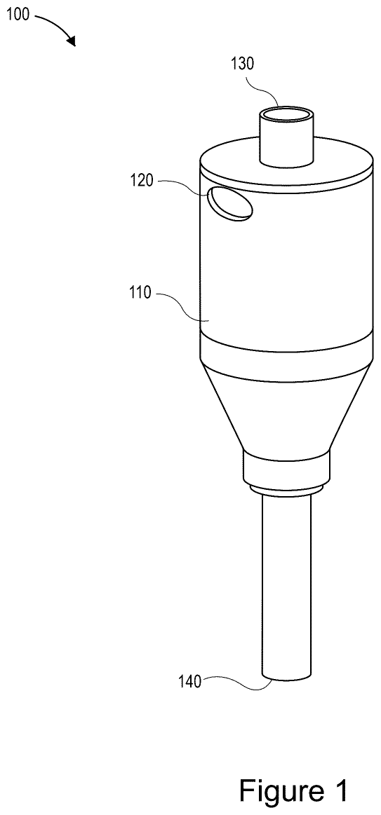

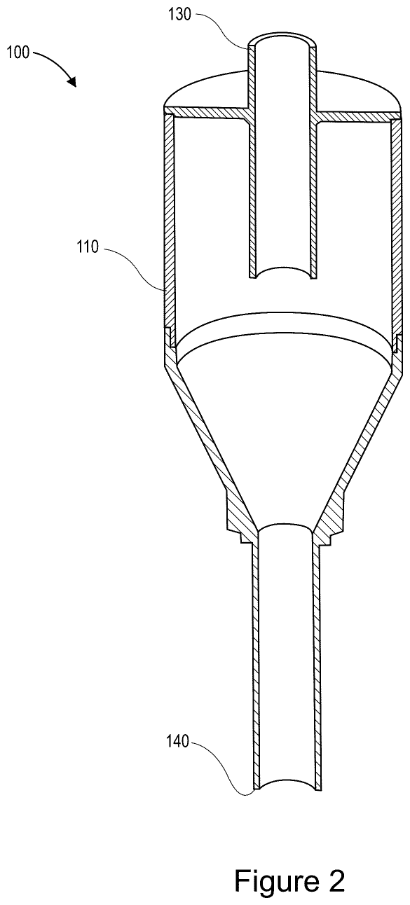

FIGS. 1 and 2 illustrate a perspective view and a cross-sectional view of a separation system 100, according to an embodiment. The separation system 100 may be or include a vortical flow (also referred to as “cyclonic”) separator. The separation system 100 may include a body 110 having a cylindrical upper portion and a conical or frustoconical lower portion. The body 110 may define a vortical flow chamber therein.

The separation system 100 may also include a tangential inlet 120 that is positioned in the upper (e.g., cylindrical) portion of the body 110. The inlet 120 may be configured to receive a mixed fluid that includes a liquid and solids (e.g., sand, proppant, or other particles) from a wellbore. The separation system 100 may be configured to separate the solids from the liquid. More particularly, the separation system 100 may be configured to cause the mixed fluid to rotate around a central longitudinal axis therethrough (e.g., like a cyclone). This may cause at least some of the solids to separate from the fluid. As mentioned above, the speed, pressure, and particulate matter (e.g., sand) of this separation process may cause wear to the inner surfaces of the body 110.

The separation system 100 may include a first (e.g., liquid) outlet 130 that is positioned in the upper (e.g., cylindrical) portion of the body 110. The liquid that the solids are removed therefrom may exit the body 110 via the liquid outlet 130.

The separation system 100 may also include a second (e.g., solids) outlet 140 that is positioned in the lower (e.g., conical) portion of the body 110. The solids that are separated from the mixed fluid may exit the body 110 via the solids outlet 140.

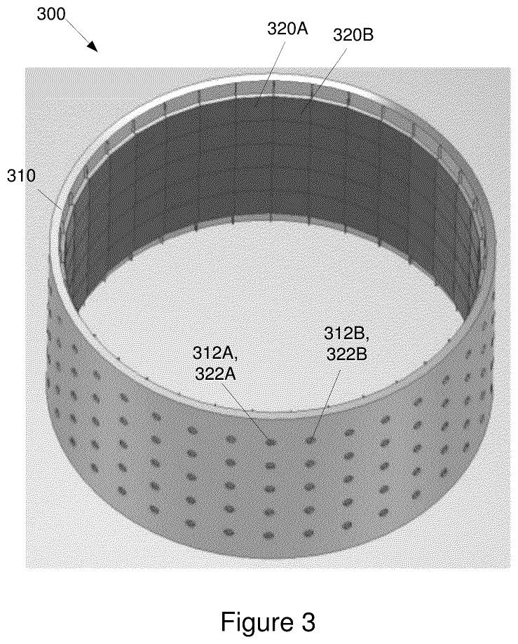

FIG. 3 illustrates a perspective view of a wear-resistant insert 300 that may be positioned within the separation system 100, according to an embodiment. The wear-resistant insert 300 is substantially cylindrical (e.g., annular) and may thus be positioned within the upper (e.g., cylindrical) portion of the body 110. However, in other embodiments, the wear-resistant insert 300 may also or instead be conical or frustoconical and be positioned within the lower (e.g., conical) portion of the body 110.

The wear-resistant insert 300 may include a base 310 and a plurality of tiles 320A, 320B. The base 310 may be annular and have a plurality of openings 312A, 312B formed (e.g., radially) therethrough. The base 310 may be positioned (e.g., radially) between the body 110 and the tiles 320A, 320B. In the embodiment shown, the tiles 320A, 320B may each include a protrusion 322A, 322B that may be positioned within or extend through a corresponding opening 312A, 312B in the base 310. The protrusions 322A, 322B may be secured therein via a friction fit, an adhesive, brazing, etc.

The base 310 and/or the tiles 320A, 320B may be made of a wear-resistant material. In one embodiment, the base 310 and/or the tiles 320A, 320B may be made of diamond-based materials, silicon carbide (SiC), tungsten carbide (WC), or a combination thereof. In one example, the base 310 and/or the tiles 320A, 320B may be made of polycrystalline diamond (PCD). In another example, the base 310 and/or the tiles 320A, 320B may comprise a composite diamond coating (CDC). More particularly, a slurry-based CDC may protect areas of the separation system 100 that face lower wear rates and/or have more complex geometries that would make tile installation difficult.

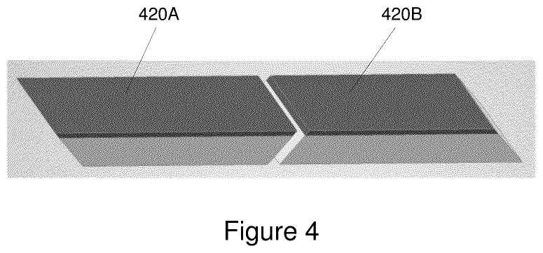

FIG. 4 illustrates a perspective view of interlocking tiles 420A, 420B, according to an embodiment. The interlocking tiles 420A, 420B may be used instead of or in addition to the square tiles 320A, 320B. In the embodiment shown, the tile 420A may include a male end that is configured to be positioned adjacent to a female end of the tile 420B. For example, the sides of the tiles 420A, 420B may be substantially trapezoidal.

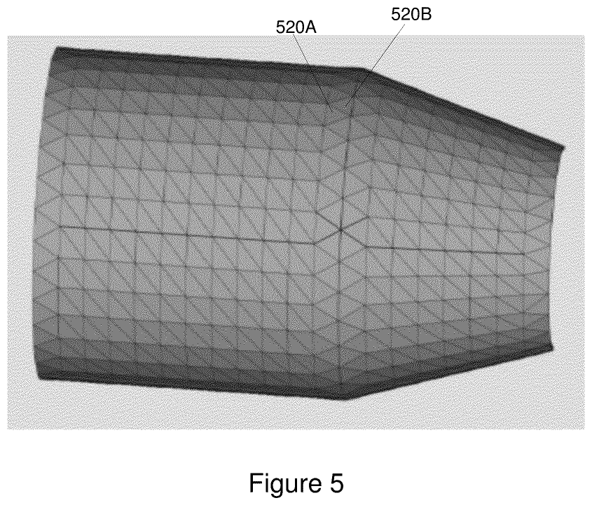

FIG. 5 illustrates a perspective view of triangular tiles 520A, 520B, according to an embodiment. The triangular tiles 520A, 520B may be used instead of or in addition to the tiles 320A, 320B and/or the tiles 420A, 420B. The sizes and shapes of the tiles 520A, 520B may differ to allow the tiles 520A, 520B to fit within the upper (e.g., cylindrical) portion of the body 110, the lower (e.g., conical) portion of the body 110, or the transition therebetween.

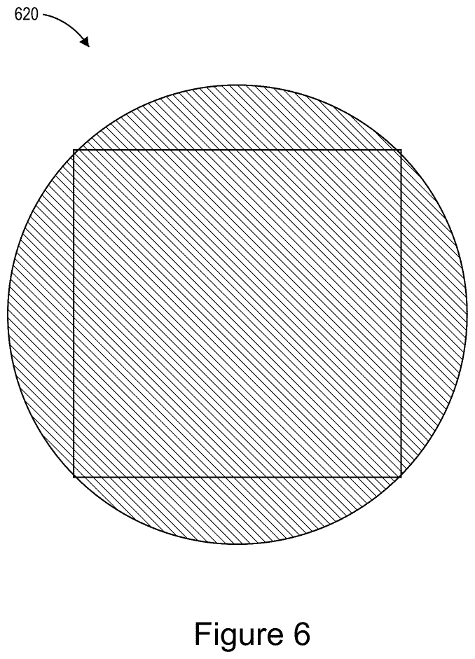

FIG. 6 illustrates a usable area of a tile 620, according to an embodiment. The tile size is limited by the standard largest disc size available from manufacturers, which determines the maximum square cut dimension achievable.

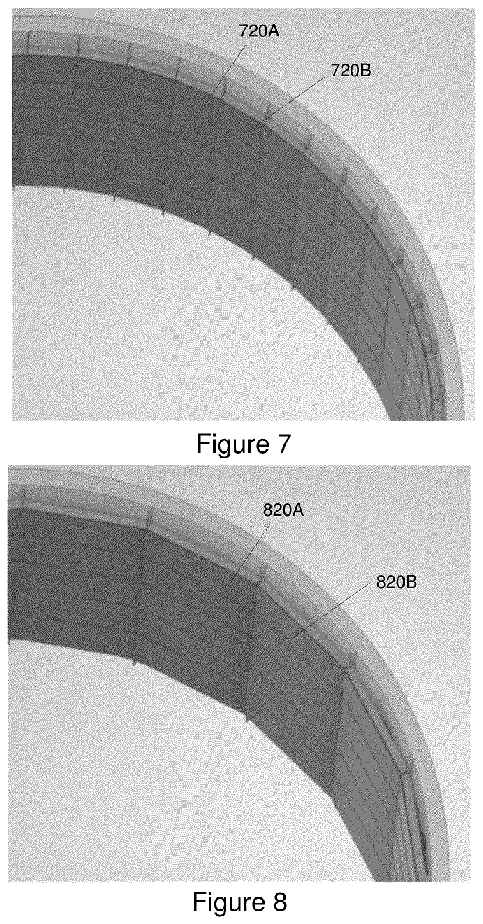

FIGS. 7 and 8 illustrate a faceted internal surface in the separation system 100 that includes small tiles 720A, 720B (FIG. 7) and large tiles 820A, 820B (FIG. 8), according to an embodiment. As mentioned above, the sizes and shapes of the tiles 720A, 720B, 820A, 820B may vary. The inner (e.g., radial) surface of the wear-resistant insert 300 including the smaller tiles 720A, 720B (as shown in FIG. 7) may more closely resemble a circle when compared to the larger tiles 820A, 820B (as shown in FIG. 8).

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A separation system, comprising
a body comprising:
an inlet configured to receive a mixed fluid, wherein the mixed fluid includes a liquid and solids;
a first outlet; and
a second outlet that is positioned below the first outlet; and
a wear-resistant insert positioned within the body, the wear-resistant insert including a plurality of tiles and at least partially defining a vortical flow chamber configured to separate the solids from the liquid, wherein the liquid exits the body via the first outlet and the solids exit the body via the second outlet.

2. The separation system of claim 1, wherein the tiles comprise diamond.

3. The separation system of claim 1, wherein the tiles comprise polycrystalline diamond (PCD) or a composite diamond coating (CDC).

4. The separation system of claim 1, wherein the wear-resistant insert also comprises a base that is positioned radially between the body and the tiles.

5. The separation system of claim 4, wherein the base defines a plurality of openings formed radially therethrough, and wherein each of the tiles comprises a protrusion that is configured to be positioned at least partially within a respective one of the openings.

6. The separation system of claim 1, wherein the tiles comprise interlocking tiles that are at least partially trapezoidal in shape.

7. The separation system of claim 1, wherein the tiles are at least partially triangular in shape, and wherein at least two of the tiles have different sizes and shapes.
